(19) United States
(12) Patent Application Publication
(10) Pub. No.: US 2007/0093587 A1
(43) Pub. Date: Apr. 26, 2007

(54) Silicon carbide precursors and uses thereof

(75) Inventors: Oionghua Shen, Latham, NY (US); Walter J. Sherwood, Clifton Park, NY (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Starfire Systems

(21) Appl. No.: 11/257,905

(22) Filed: Oct. 25, 2005

(51) Int. Cl. C08K 3/38; C08K 3/22; C08K 3/34

(52) U.S. Cl. 524/443; 524/404; 524/413

(57) ABSTRACT

A silicon composition comprising a copolymer is provided. The copolymer has the formula H—[SiH₂CH₂]ₓₙ[Si(R₁)HCH₂]_{yn}[SiH(R₂)CH₂]_{zn}—H wherein R₁ is methyl, phenyl, methoxy, ethoxy, or butoxy; wherein R₂ is allyl, propargyl, or ethynyl; and wherein x+y+z=1 with the proviso that x, y, and z are not 0. Methods for making silicon carbide based materials using the aforementioned copolymer and articles made thereby are also provided.

### BACKGROUND

The present invention relates to a silicon carbide precursor and uses thereof. More particularly, the present invention relates to a three component silicon carbide precursor.

Carbosilane polymers are known as precursors to silicon carbide ceramics. Illustrative silicon carbide precursors are described in U.S. Pat. No. 5,153,295 to Whitmarsh et al., which is hereby incorporated by reference in its entirety. These polymers are often referred to as pre-ceramic polymers. The polymers of Whitmarsh et al. are characterized in that substantially all of the linkages between the Si—C units are “head-to-tail”, i.e. they are Si to C.

Silicon carbide has special utility as a coating material for a wide variety of substrates forms and materials including solid surfaces, two and three dimensional fiber performs, yarns, felts, woven materials, tube bores, and pre-shaped parts. Coatings can be applied to the substrate by various techniques in which a silicon carbide precursor composition is first applied to the substrate by means such as painting, spraying, and liquid infiltration. The precursor composition is then cured, if necessary, and then pyrolyzed to form the silicon carbide coating. Chemical vapor infiltration and chemical vapor deposition can be used to form coatings of varying thickness from low molecular weight vaporizable precursors in a single step or in multiple incremental steps.

Silicon carbide is a ceramic material which is recognized as useful in a wide variety of applications such as electronics, engine components, low friction bearings, thermal and environmental barrier coatings, wear resistance parts such as brakes and other applications in which high strength, thermal stability, oxidation and corrosion resistance, and low density are required. Hence, there remains a need to develop compositions that can be used to produce silicon carbide ceramic materials.

### SUMMARY

The present invention provides a silicon composition comprising a copolymer having the formula:
H—[SiH₂CH₂]ₓₙ[Si(R₁)HCH₂]_{yn}[SiH(R₂)CH₂]_{zn}—H

wherein R₁ is methyl, phenyl, methoxy, ethoxy, or butoxy;

wherein R₂ is allyl, propargyl, or ethynyl; and

wherein x+y+z=1 with the proviso that x, y, and z are not 0.

In an embodiment, the present invention provides a method for making a silicon carbide based material comprising heating a copolymer of the formula:
H—[SiH₂CH₂]ₓₙ[Si(R₁)HCH₂]_{yn}[SiH(R₂)CH₂]_{zn}—H

wherein R₁ is methyl, phenyl, methoxy, ethoxy, or butoxy;

wherein R₂ is allyl, propargyl, or ethynyl; and

wherein x+y+z=1 with the proviso that x, y, and z are not 0.

In another embodiment, there is provided a method for making a composition comprising:

a) placing a mixture in a mold wherein the mixture includes at least one powder, at least one reinforcement material, liquid furfural, a catalyst, and a copolymer having the formula:
H—[SiH₂CH₂]ₓₙ[Si(R₁)HCH₂]_{yn}[SiH(R₂)CH₂]_{zn}—H

wherein R₁ is methyl, phenyl, methoxy, ethoxy, or butoxy;

wherein R₂ is allyl, propargyl, or ethynyl; and

wherein x+y+z=1 with the proviso that x, y, and z are not 0;

b) applying pressure to the mold in a range between about 500 psi and about 5000 psi; and

c) heating the molded mixture to a temperature in a range between about 700° C. and about 1200° C.

In a further embodiment of the present invention, there is provided a method for making a composition comprising:

a) placing a reinforcing material and a slurry in a furnace wherein the mixture includes at least one powder and a copolymer having the formula
H—[SiH₂CH₂]ₓₙ[Si(R₁)HCH₂]_{yn}[SiH(R₂)CH₂]_{zn}—H

wherein R₁ is methyl, phenyl, methoxy, ethoxy, or butoxy;

wherein R₂ is allyl, propargyl, or ethynyl; and

wherein x+y+z=1 with the proviso that x, y, and z are not 0;

b) applying a vacuum of about 100 millitorr to about 500 millitorr to the furnace; and

c) heating the reinforcing material and the slurry to a temperature in a range between about 1200° C. to about 1800° C.

### DESCRIPTION OF THE INVENTION

A silicon carbide precursor disclosed in the present invention is a three component copolymer. The copolymer may be used as a binder or coating to produce a final silicon carbide material. The silicon carbide precursor copolymer has a backbone of silicon linked to carbon in a head to tail configuration with controlled side groups.

The silicon carbide precursor of this invention is a copolymer of the following formula:
H—[SiH₂CH₂]ₓₙ[Si(R₁)HCH₂]_{yn}[SiH(R₂)CH₂]_{zn}—H

wherein R₁ is, independently at each occurrence, methyl, phenyl, methoxy, ethoxy, or butoxy; wherein R₂ is, independently at each occurrence, allyl, propargyl, or ethynyl; and x+y+z=1 with the proviso that x, y, and z are not 0. Hence, the copolymer includes three components. In an embodiment, n is in a range from about 10 to about 140 and in an embodiment, n is in a range from about 20 to about 80. The molecular weights for the copolymers of the present invention range from about 500 Mn to about 7000 Mn, and in an embodiment, in a range from about 1000 Mn to about 4000 Mn.

The copolymers of the present invention can be varied stoichiometrically by varying the stoichiometric ratio of silicon (Si) to carbon (C) to hydrogen (H). The stoichiometric ratio can be controlled and predetermined by changing the substituents, R₁ and R₂, as well as by varying the values of x, y, and z. Thus, the properties of the final silicon carbide product made from the copolymer precursor can be predetermined and controlled for a chosen application. When the ratio of silicon/carbon is about 1.0, also known as stoichiometric silicon carbide (SiC), the SiC ceramic is most thermally stable and the copolymer also contains the greatest amount of silicon hydride. The silicon hydride is reactive with metals, oxides, and carbon. Stoichiometric SiC is best for where stability is required in operating temperatures greater than about 1400° C., corrosive environments, or oxidizing atmospheres. Copolymers with a high ratio of carbon compared to stoichiometric SiC produce ceramics with excess carbon and hence, are less reactive than stoichiometric SiC and tend to form high melting point carbides which melt at temperatures in excess of 2000° C. when metallic fillers such as titanium carbide, hafnium carbide, and zirconium carbide are used. These high ratio carbon copolymers also function as mold releases and fiber coatings. Copolymers with lower Si—H content are less reactive than stoichiometric polymer, and are typically used as fiber coatings, mold releases, low cost matrix materials for glass fiber reinforced composites, and matrices for carbon fiber reinforced composites and low friction materials such as bearings. Low hydrogen content is usually due to a large number of carbon bearing substituents on the silicon atoms in the polymer compared to stoichiometric polymer.

For instance, in an embodiment of the present invention, R₁ is methyl, R₂ is allyl, x is in a range between about 0.6 and about 0.9, y is in a range between about 0.1 and about 0.15, and z is in a range between about 0.05 and about 0.1.

In an embodiment, R₁ is methyl, R₂ is allyl, x is in a range between about 0.6 and about 0.9, y is in a range between about 0.07 and about 0.08, and z is in a range between about 0.07 and about 0.08.

In an embodiment, R₁ is phenyl, R₂ is allyl, x is in a range between about 0.6 and about 0.9, y is in a range between about 0.1 and about 0.3, and z is in a range between about 0.05 and about 0.3.

In an embodiment, R₁ is methyl, R₂ is ethynyl, x is in a range between about 0.6 and about 0.9, y is in a range between about 0.1 and about 0.3, and z is in a range between about 0.05 and about 0.3.

In an embodiment, R₁ is methyl, R₂ is propargyl, x is in a range between about 0.6 and about 0.9, y is in a range between about 0.1 and about 0.3, and z is in a range between about 0.05 and about 0.3.

In an embodiment, R₁ is phenyl, R₂ is propargyl, x is in a range between about 0.6 and about 0.9, y is in a range between about 0.1 and about 0.3, and z is in a range between about 0.05 and about 0.3.

In an embodiment, R₁ is methyl, R₂ is allyl, x is in a range between about 0.1 and about 0.3, y is in a range between about 0.6 and about 0.8, and z is in a range between about 0.1 and about 0.2.

In an embodiment, R₁ is methyl, R₂ is allyl, x is in a range between about 0.2 and about 0.25, y is in a range between about 0.1 and about 0.2, and z is in a range between about 0.55 and about 0.7.

In an embodiment, R₁ is phenyl, R₂ is propargyl, x is in a range between about 0.2 and about 0.25, y is in a range between about 0.1 and about 0.2, and z is in a range between about 0.55 and about 0.7.

In an embodiment, R₁ is phenyl, R₂ is allyl, x is in a range between about 0.1 and about 0.3, y is 0.4, and z is in a range between about 0.35 and about 0.45.

In an embodiment, R₁ is methyl and R₂ is, independently at each occurrence, propargyl, or ethynyl.

In an embodiment, R₁ is, independently at each occurrence, phenyl, methoxy, ethoxy, or butoxy and R₂ is allyl.

The copolymer of the present invention is obtained by a Grignard coupling process starting from a methoxylated chlorocarbosilane followed by a reduction process using any useful reduction agent, for example, lithium aluminum hydride (LiAlH₄), sodium aluminum hydride (NaAlH₄), sodium hydride (NaH) and the like.

The copolymer of the present invention can be used in the formation of ceramic materials. In particular, the copolymer forms silicon carbide ceramic materials wherein the silicon-carbon backbone copolymers are cross-linked through hydrogen contained on side groups off the silicon-carbon backbone. “Ceramic” as used herein refers to high purity ceramics, semi-ceramic materials, near-ceramic materials, amorphous ceramic materials, nanocrystalline ceramic materials, and the like. The ceramic can be formed by a variety of thermal or radiation methods, including pyrolysis, plasma or plasma enhanced treatments, laser heating, electric arc forming, and anaerobic combustion of the silicon carbide precursor.

In an embodiment, the copolymer of the present invention is used to make a high purity silicon carbide ceramic via a thermal or radiation method which causes cross-linking and curing of the copolymer. “High purity” as used herein refers to a ceramic with a silicon-carbon backbone, i.e. silicon carbide, with carbon impurities in a range between about 0.1% to about 4% by weight of the total ceramic material, oxygen impurities in a range between 0.1% to about 4% by weight of the total ceramic material, and parts per million levels of other impurities. In an embodiment, the level of impurities is less than about 0.1% by weight of the total ceramic material. Curing of high purity silicon carbide ceramics typically occurs at temperatures in a range between about 160° C. and about 500° C. In one embodiment, the curing occurs at a temperature in a range between about 200° C. and about 300° C. The copolymer is typically heated for a time period in a range between about 30 minutes and about 240 minutes. The typical thermal curing process without a catalyst is 1 hour at a temperature in a range between about 350° C. and about 400° C.

The silicon carbide precursor of the present invention may also be used to produce hardened near-ceramic coatings and matrices. “Near-ceramic materials” as used herein refers to Si-based pre-ceramic materials containing both Si—H and C—H bonding that have been cured and heated. The copolymer is cross-linked by substantial removal (i.e., greater than about 80%) of the Si—H bonding while leaving the majority of the C—H bonding intact (i.e., greater than about 90%), producing materials with unique properties such as a near-ceramic material with some of the toughness of an organic resin but capable of sustained use at greater than about 500° C. and hardness greater than about 1000 GPA. In an embodiment, the near-ceramic material is produced by heating the silicon carbide precursor to a temperature in a range between about 400° C. and about 650° C. In an embodiment, the silicon carbide precursor is heated to a temperature in a range between about 500° C. and about 700° C. Typically, roughly 40% of the original hydrogen on the precursor copolymer remains at 500° C. and only 25% at 700° C. (depending on the ratio of Si—H compared to C—H in the precursor copolymer). In an embodiment, the copolymer is heated at a heating rate of about 0.1° C./min to about 15° C./minute, preferably at a heating rate of about 0.5° C./minute to about 3° C./minute and holding for a time period in a range between about 5 minutes and about 2 hours. The copolymer may be heated in an inert gas environment (for example, nitrogen, argon, or helium), a hydrogen gas environment, or combinations thereof to produce the near-ceramic material.

Near-ceramic materials of the present invention can be used in fiberglass based circuit boards that have stiffness greater than about 30 GPa and a thermal expansion coefficient near to that of silicon (about 2-3 ppm/° C.). Additional uses for near-ceramic materials of the present invention include fire and flame resistant flexible panels.

In an embodiment, amorphous silicon carbide based ceramic matrices and coatings are produced. “Amorphous” as used herein refers to a silicon carbide material that is glass-like with no discernable crystal structure. Typically, an amorphous silicon carbide based ceramic material can be produced by heating the copolymer of the present invention under inert gas, hydrogen gas, or combination thereof to a temperature of about 700° C. to about 1200° C. and in an embodiment, a temperature in a range between about 850° C. and about 900° C. Typically, the heating rate is about 0.1° C./min to about 15° C./minute, preferably at a heating rate of about 0.5° C./minute to about 3° C./minute, and the temperature is held for a time period in a range between about 5 minutes to about 2 hours. Pressure may also be applied to the mold in a range between about 500 psi and about 5000 psi.

In an embodiment, the copolymer may be reinfiltrated after heating. During reinfiltration, the article is removed from the furnace, placed in a vacuum to substantially remove trapped air (where less than about 99% of the air is present), and infused with a copolymer of the present to fill in the voids/cracks formed by shrinkage as the polymer ceramatized during the pyrolysis cycle. In an embodiment, the vacuum is at a pressure of about 100 to about 500 millitorr at a temperature in a range between about 10° C. and about 80° C. The reinfiltration process is typically followed by another pyrolysis cycle. In an embodiment, the pyrolysis cycle that occurs after reinfiltration is at a temperature of about 700° C. to about 1200° C. and in an embodiment, a temperature in a range between about 850° C. and about 900° C. Reinfiltration and pyrolysis may be repeated typically between 1 and 16 cycles. Typically, the greater number of cycles, the lower the porosity of the article. Articles with porosities in the range of about 0.5% (which can be used to produce hermetically sealed or non-porous articles) to about 45% (which can be used for filtration) can be fabricated. In an embodiment, the porosity is in a range between about 2% and about 10%.

Amorphous SiC matrix composites are utilized as low to intermediate energy friction materials such as motorcycle brake rotors, automotive brake rotors, high stiffness circuit boards, flexible C/SiC thin structures for aerospace applications, industrial/chemical process materials such as distillation tower packing, and the like.

In an embodiment, nanocrystalline SiC-based ceramic matrices and coatings are produced. Typically, nanoctystalline SiC-based materials can be produced by heating the copolymer of the present invention to a temperature of about 1200° C. to about 1800° C. and in an embodiment, to a temperature of about 1600° C. to about 1800° C. Typically, the heating rate is about 0.1° C./min to about 15° C./minute and in an embodiment, about 0.5° C./minute to about 3 degrees C./minute. Typically, the temperature is held for a time period in a range between about 5 minutes and about 3 hours and in an embodiment, in a range between about 1 hour and about 2 hours. In an embodiment, the heating is performed under inert gas, hydrogen gas, or combination thereof. Typically, a vacuum pressure of about 100 millitorr to about 500 millitorr is applied to the furnace.

In an embodiment, the copolymer may be reinfiltrated as described above. The reinfiltration process is typically followed by another pyrolysis cycle. In an embodiment, the pyrolysis cycle after reinfiltration may occur at a temperature in a range between about 850° C. and about 1600° C. and in an embodiment, at a temperature in a range between about 850° C. and about 1000° C. Reinfiltration and pyrolysis may be repeated typically between 1 and 16 cycles to produce a nanocrystalline, SiC-based ceramic material with a porosity in a range between about 0.5% (16 cycles) and about 45% (1 cycle). In an embodiment, the porosity is in a range between about 2% and about 10%.

Nanocrystalline SiC-based matrices are used for applications wherein temperatures greater than about 1400° C. are required such as high energy brake rotors for aircraft, heavy trucks, trains, and the like. Other examples of use include thermal protection systems on spacecraft (which function as the “heat shield” during re-entry) or rocket exhaust nozzles. Often in this embodiment, the polymer is filled with one or more refractory powders such as hafnium diboride, hafnium carbide, zirconium diboride, zirconium oxide, or refractory metals such as hafnium, zirconium, strontium, titanium, or tantalum (typically in the form of butoxides which are liquids that are miscible with the SiC forming copolymers).

Prior to thermal processing, the silicon carbide precursor copolymer disclosed in the present invention is in liquid form. The silicon carbide copolymer precursor can be used as a vehicle to hold powders in a liquid suspension for coating fibers, fiber based composites, and woven structures. The silicon carbide copolymer may also be used for joining, sealing, or coating porous and non-porous materials. When coating a porous material, the copolymer may function as a smoothing agent, a sealing agent, a surface hardening agent, or any combination thereof. “Porous materials” include graphite, carbon/carbon (C/C) composites, and oxide based ceramics such as alumina, firebrick, fireclay, furnace insulation, and the like.

The silicon carbide copolymer precursor of the present invention can be used in conjunction with a variety of substrate forms and materials. Typical materials include graphite, silicon, silica (quartz), alumina, zirconia, various carbides (for example, boron carbide, silicon carbide, tungsten carbide, chrome, and the like), and other oxides and nitride ceramics. The copolymers can be used as seal coatings on porous substrates, or as mold releases on both porous and non-porous substrates. The silicon carbide copolymer precursor may be used to form a molding compound wherein the precursor, typically mixed with powder, is molded or pressed into a mold. Additionally, the silicon carbide precursor can be used to coat metals and metal alloys of various types. These include copper, steel, stainless steel, nickel alloys, titanium alloys, aluminum alloys, brass, molybdenum, chromed steel, and the like.

When the copolymer is used as a coating, it can be applied to the surface of a substrate by a variety of means such as painting, dipping, spraying, and liquid infiltration followed by decomposition to form the silicon carbide coating. The term “substrate” as used herein refers to a body having one or more surfaces on which coatings can be deposited. Bodies include tubes, blocks, fibers, fabrics composed of single fibers or combinations of fibers and other bodies, irregular shapes bodies, and coated surfaces such as carbon coated fibers or other shapes having a coating of carbon or other composition such as a nitride, carbide, boride, or the like.

In an embodiment, the copolymer may be used with powders, whiskers, chopped fiber, continuous fiber, plies, platelets, felts, and the like. Included are copper, aluminoborosilicate, silicon carbide (SiC), carbon, pitch-based carbon, graphite, alumina, aluminosilicate, S-glass, E-glass (S-Glass is a high strength, low alkali glass fiber with higher temperature capability, while E-glass is essentially “window glass” spun into fibers), and silica as well as a variety of fiber structures (such as felt, woven, braided, chopped fiber, and knits) can be used. Exemplary aluminosilicate fibers include, but are not limited to, Nextel 312, Nextel 312BN, Nextel 440, Nextel 550, and Nextel 720, while Nextel 610 is an alumina (aluminum oxide) fiber (all “Nextel” materials are trademarked by 3M Company). Exemplary silicon carbide type fibers include, but are not limited to those with trade names such as Tyranno SA, Tyranno ZMI (all trademarked by UBE Industries); Hi-Nicalon, Hi-Nicalon Type S, (trademarked by Nippon Carbon, Inc.) or Sylramic (trademarked by Dow Corning/ATK).

In an embodiment, the non-carbon fibers have a fiber coating of about 0.01 micron to about 0.55 micron thick. Fiber coatings such as pyrocarbon, boron nitride, or boron nitride/silicon carbide, or polymer-derived SiC, SiC—C, or Si—C—O can be used to enhance the toughness of silicon carbide ceramic products that are manufactured or used at temperatures greater than about 500° C.

In an embodiment, the SiC forming copolymers of the present invention can also function as the matrix for carbon-fiber reinforced materials. Exemplary carbon-fiber reinforced material includes polyacrylonitrile-based carbon fiber cloth, petroleum pitch-based fiber, chopped fiber, felt, and combinations thereof. In the case where the carbon fibers are petroleum pitch (coal tar) based and processed at temperatures greater than about 2000° C., no fiber coating is needed to protect the fibers from the polymer. However, a SiC based copolymer with low hydrogen content and higher phenyl substituent content (compared to stoichiometric SiC) can be used to improve the bonding of the copolymer-derived ceramic matrix to the fibers and thereby enhancing the strength of the composite.

In an embodiment, when carbon fibers or cloth that is based on polyacronitrile (PAN) are used, the fibers or cloth must be either coated with pyrocarbon or heat treated in vacuum or inert gas to a minimum of 1600° C. for a minimum of 2 hours in order to stabilize the fiber and permit the use of the fibers in the SiC forming copolymer matrices.

When powders are added to the copolymer, a slurry is formed. Slurries are typically used to form the ceramic coated fabric or fiber for ceramic composites. Typically, the powders are present in a range between about 1% to about 50% by weight of the total mixture. In an embodiment, the powders are present in a range between about 2 and about 25% by weight of the total mixture. In an embodiment, the powders are present in a range between about 10% to about 65% by weight of the total mixture. Slurries used to smooth, harden, or seal porous materials typically contain powders in the range between about 5% to about 20% by volume depending on the powder size and the thickness of the coating desired.

Powders include graphite, silicon, silica (quartz), alumina, zirconia, various carbides (for example, boron carbide, silicon carbide, tungsten carbide, chrome, and the like), and other oxides and nitride ceramics. High temperature refractory carbide, boride, oxide, and nitride powders such as hafnium diboride, hafnium carbide, zirconium diboride, zirconium oxide, etc. can also be used. Further exemplary powders include glassy carbon, petroleum coke, copper, iron powder, titanium, zirconium, zirconia, silica (quartz), silicon, and the borides, carbides, nitrides, and oxides of aluminum, silicon, boron, titanium, molybdenum, tungsten, hafnium, zirconium, niobium, chromium, tantalum, individually or mixtures thereof. In an embodiment, the powder has a size in a range between about 0.5 microns and about 45 microns. Powder size for fine powders, as defined herein, can range from about 10 nanometers to about 7 micrometers, with the preferred range being about 0.4 micrometers to about 4 micrometers. In an embodiment, bimodal powders may be used. In an embodiment, the bimodal powders may include particles in a range between about 4 microns and about 7 microns and particles in a range between about 0.5 microns and about 0.8 microns.

In an embodiment, the copolymer may contain from about 0.25% to about 5% by weight boron added to the copolymer in the form of a boron containing complex or by dissolving small (1-5% by mass) quantities of materials such as decaborane. Generally, the polymer content of the starting composition for molding compound can be from about 5% to about 25% polymer by mass with the preferred ratio being from about 7% to about 15%. The amount of powder is selected to provide the proper consistency of the composition for the type of pressing, extruding or other forming technique to be used.

In an embodiment, the addition of at least one powder to the copolymer may increase the temperature at which the final ceramic material can withstand before degradation. In an embodiment, the addition of at least one powder such as hafnium diboride, hafnium carbide, zirconium diboride, zirconium carbide, silicon carbide, or silicon nitride, produces a final ceramic material that can withstand a temperature of about 1600° C. to about 2800° C. before degradation.

In an embodiment, the addition of at least one powder may be used to produce low thermal expansion (less than about 5 ppm/° C.), higher modulus (greater than about 100 GPa) ceramic fiber, glass fiber, and/or carbon fiber reinforced circuit board or packaging applications. Exemplary powders for such application include, but are not limited to, silicon carbide, boron carbide, or silicon nitride.

In an embodiment, the addition of at least one powder may be used to produce packing and structural materials for chemical processing components such as distillation or gas scrubbing (pollution control) tower packing. Exemplary powders for such application include, but are not limited to, silicon carbide, carbon, graphite, boron carbide, or silicon nitride.

A platinum catalyst may also be used to form the final silicon carbide material. The platinum catalyst decreases the temperature or time at which the polymer gels or cures. Typically, the platinum catalyst is a zero-state catalyst. Exemplary zero-state platinum catalysts include chloroplatinic acid, and most platinum complexes. In an embodiment, the platinum catalyst used is present in a range between about 1 parts per million (ppm) to about 15 ppm of the mass of the copolymer used. In an embodiment, the platinum catalyst is present in a range between about 15 ppm and about 50 ppm. Other alternative gelling/crosslinking/curing agents include, boron-hydrogen compounds such as decaborane, silanol containing compounds, as well as most amine compounds. In an embodiment, the alternative curing agent used is present in a range between about 1 parts per million (ppm) to about 15 ppm of the mass of the copolymer used. In an embodiment, the curing agent is present in a range between about 15 ppm and about 50 ppm.

In an embodiment, oxygen may be introduced into the silicon carbide ceramic composition as silicon-oxygen bonds. Introduction of oxygen may be through the use of methoxy, ethoxy, or butoxy in the silicon carbide copolymer precursor or through heating the silicon carbide copolymer precursor in a moist environment. “Moist environment” as used herein refers to a relative humidity of at least about 60% and in embodiments, at least about 80%. Typically, the temperature is in a range between about 90° C. and about 200° C. and in embodiments, in a range between about 125° C. and about 180° C. Heating in the moist environment typically occurs for a time period of about 1 hour to about 6 hours. In an embodiment, the copolymer is heated in a moist environment for a time period in a range between about 1 hour and about 2 hours at a temperature of about 160° C. Typically, the addition of oxygen produces a low dielectric ceramic material. In an embodiment, the copolymer may be used to produce low dielectric coatings. “Low dielectric” as used herein refers to a dielectric constant less than about −3.0.

In an embodiment, further additives may be used to produce the final silicon carbide material. Additives include liquid furfural and diluents such as solvents, non-polar organic liquids, and wetting agents. The liquid furfural may be present in range between about 5% and about 15% of by weight of the total mixture. In an embodiment, the liquid furfural may be present in a range between about 25% and about 50% by weight of the total mixture. The liquid furfural may be used to form glassy carbon or graphite for controlling friction properties of the final ceramic material. Solvents may also be used to dilute the copolymer. Exemplary solvents include hexane, tetrahydrofuran (THF), butyl ether, toluene, acetone, or other non-polar organic solvents. In an embodiment, the solvent is present in a range between about 10% by weight and about 95% by weight of the total mixture. In an embodiment, the solvent is present in a range between about 10% by weight and about 20% by weight of the total mixture. Non-polar organic liquids include mineral spirits and the like. In an embodiment, the mineral spirits are present in a range between about 2% by weight and about 15% by weight of the total mixture. Wetting agents include, for example, polyglycol, fish oil, oleic acid, polyoleic acid, ethylene glycol, and the like. In an embodiment, the wetting agent may be present in a range between about 0.2% by weight and about 2% by weight of the total mixture.

The Examples which follow illustrate various embodiments of the present invention.

### EXAMPLES

The present invention includes the preparation of new precermaic polycarbosilanes with a composition of H—[SiH₂CH₂]ₓₙ[SiMe(H)CH₂]_{yn}[SiRHCH₂]_{zn}—H , where R could be H, allyl, propargyl, and ethynyl groups; x+y+z=1 with the proviso that x, y, and z are not 0.

As shown in the following equations, the copolymers of the present invention were prepared in four steps:
Cl₃SiCH₂Cl+1.75MeOH→Cl_{1.25}(OMe)_{1.75}SiCH₂Cl (1)
nCl_{1.25}(OMe)_{1.75}SiCH₂Cl+znR₂Cl+Mg+THF→[Si(OMe)₂CH₂]_{(1-z)n}[SiR₂(OMe)CH₂]_{zn} (2)
[Si(OMe)₂CH₂]_{(1-z)n}[SiR₂(OMe)CH₂]_{zn}+ynMeCl₂SiCH₂Cl+Mg+THF→[Si(OMe)₂CH₂]_{(1-y-z)n}[SiMe(Cl)CH₂]_{yn}[SiR₂(OMe)CH₂]_{zn} (3)
[Si(OMe)₂CH₂]ₓₙ[SiMe(Cl)CH₂]_{yn}[SiR₂(OMe)CH₂]_{zn}+LiAlH₄→[SiH₂CH₂]ₓₙ[SiMe(H)CH₂]_{yn}[SiR₂(H)CH₂]_{zn} (4)

Where x=1−y−z, or x+y+z=1

The first step was a partial methoxylation of chloromethyltrichlorosilane. The methoxylation ratio, i.e., the mole ratio of MeOH/Cl₃SiCH₂Cl, ranged from 1.5 to 2.5. The most preferable ratio was 1.75. The obtained product from methoxylation was utilized directly in the following Grignard reaction without purification. Allyl chloride was then mixed together with Cl_{1.25}(OMe)_{1.75}SiCH₂Cl in THF. This mixture was added to Mg powder to conduct the Grignard reaction. The obtained methoxy substituted polymer, [Si(OMe)₂CH₂]_{(1-z)n}[SiR₂(OMe)CH₂]_{zn} should also contain some [Si(OMe)ClCH₂] unit, which can be reduced to [SiH₂CH₂] structure in the same way as [Si(OMe)₂CH₂] unit, thus the [Si(OMe)ClCH₂] unit is not specifically included in [Si(OMe)₂CH₂]_{(1-z)n}[SiR₂(OMe)CH₂]_{zn} formula. Right after the addition of allyl chloride and Cl_{1.25}(OMe)_{1.75}SiCH₂Cl to the mixture, MeCl₂SiCH₂Cl in THF was added to continue the Grignard reaction. The resultant mixture was stirred under 50° C. for 24 h. Reduction reaction was achieved by adding LiAlH₄. The desired polymer was separated by an aqueous work-up of the mixture from the reduction reaction.

The shelf-life of commerical SMP-10 (AHPCS— from U.S. Pat. No. 5,153,295, to Whitmarsh et al.) is limited to several months due to the existence of large amount of SiH₃. In this invention, by adding MeCl₂SiCH₂Cl in the Grignard step, the final polycarbosilane will contain less Si—H groups compared to commercial SMP-10, especially less SiH₃ end groups, which could substantially increase the polymer's shelf life.

(1) Methoxylation

3494.5 g (19 mols) of chloromethyltrichlorosilane was placed in a 5 L three-necked round bottom flask equipped with a pressure-equalizing dropping funnel, a magnetic stirrer, and a reflux condenser fitted with a nitrogen gas outlet. Tygon tubing connected to this gas outlet was positioned over water in a large plastic container to absorb the by-product HCl gas. An inlet gas tube was connected at the top of the dropping funnel to flush the flask continuously with nitrogen gas. 1064 g (33.25 mols) of anhydrous methanol was added drop wise over 3 h while the reaction solution was stirred magnetically. The nitrogen gas flush kept the reaction purged of the by-product HCl gas, which was absorbed by the water. After the addition of methanol was completed, the solution was further stirred for 12 h at room temperature. The composition of the final product from this procedure was about 70-75% Cl(MeO)₂SiCH₂Cl, 20-25% Cl₂(MeO)SiCH2Cl, and 0-5% (MeO)₃SiCH₂Cl. This mixture was used directly in the next step reaction without purification.

(2) Grignard Coupling Reaction from Cl_{1.25}(OMe)_{1.75}SiCH₂Cl

316.8 g (13.2 mols) of Mg powder (−50 mesh) and 400 ml of anhydrous tetrahydrofuran (THF) were placed in a 12 L three-necked round bottom flask. The flask was fitted with a dropping funnel, a mechanical stirrer, and a reflux condenser fitted with a gas inlet and supplied with dry nitrogen. 1585 g of Cl_{1.25}(OMe)_{1.75}SiCH₂Cl (9 mols) was mixed with 2 L of anhydrous THF and 76.5 g (1 mol) of allylchloride in the dropping funnel. When the Cl_{1.25}(OMe)_{1.75}SiCH₂Cl mixture was added to the Mg powder, the Grignard reaction started immediately. The solution became warm and developed to a dark brown color. Throughout the addition, the reaction mixture was maintained at a gentle reflux by adjusting the addition rate of the starting material and cooling the reaction flask by cold water. The starting material was added in 3 h. The resultant mixture was stirred at room temperature for 30-60 minutes. At this stage, a polymer with a [Si(OMe)₂CH₂]_{0.8n}[Si(allyl)(OMe)CH₂]_{0.1n} formula was formed.

(3) Grignard Reaction from MeCl₂SiCH₂Cl

163.5 g (1 mol) of MeCl₂SiCH₂Cl and 600 ml of anhydrous THF were mixed in the same dropping funnel from the above reaction. The obtained solution was added to the mixture from the Grignard reaction of Cl_{1.25}(OMe)_{1.75}SiCH₂Cl within 2 h. The Grignard reaction from MeCl₂SiCH₂Cl was very similar to that from Cl_{1.25}(OMe)_{1.75}SiCH₂Cl. When the reaction became warm again, it was cooled by cold water. After the addition of MeCl₂SiCH₂Cl was completed, the resulting mixture was stirred at room temperature for 1 h. A heating mantle was then placed under the 12 L flask and the mixture was heated to 50° C. overnight to finish the coupling reaction. At this stage, a polymer (allyl-methoxypolycarbosilane) with a [Si(OMe)₂CH₂]_{0.8n}[SiMeClCH₂]_{0.1n}[Si(allyl)(OMe)CH₂]_{0.1n} formula was formed

(4) Reduction

The reaction flask with the mixture from (3) was cooled in an ice/water bath. Then, 1 L anhydrous THF and 200 g of LiAlH₄ pellets were added to reduce the allyl-methoxypolycarbosilane. The reaction solution became warm and the LiAlH₄ pellets dissolved gradually. When the solution became too viscous to stir, another 1 L of THF was added. The exothermic period from the reduction was about 2 h. When the exothermic period was over, the 12 L flask was placed under a heating mantle and the reduction reaction was heated at 50° C. overnight with strong agitation.

(5) Work-Up

To a 30 L plastic container, 2.2 L of concentrated HCl was mixed with 10 kg of crushed ice and 1.5 L of hexane. The solution was stirred vigorously by a mechanical stirrer. The mixture from reduction reaction (4) was poured into the rapidly stirred cold hexane/HCl solution over 30 minutes. Once the addition of the reduction mixture was completed, the work-up solution was stirred for another 10 minutes. After the stirring was stopped, a yellow organic phase appeared above the aqueous layer. The organic phase was separated and washed with 500 ml of dilute (1M) HCl solution, then dried over Na₂SO₄ for 12 h. Finally, the solvents (hexane/THF) were stripped off by a rotary evaporator to give 403 g of clear, viscous yellow polymer. This polymer had a [SiH₂CH₂]_{0.8n}[SiMe(H)CH₂]_{0.1n}[Si(allyl)(H)CH₂]_{0.1n} formula and its molecular weight was typically distributed in the range of 1000 to 7000.

### Example 1

Thin Ceramic Composite Plates for Electronic Substrates Were Made Using the Following Process:

Seven fabric plies of dimensions 12.5 inches long by 12.5 inches wide were cut from a roll of aluminoborosilicate fiber cloth with the trade name “Nextel 312”. The plies were then coated with a slurry composed of a copolymer of the present invention where R₁ was methyl and R₂ was allyl with x in the range of 0.8-0.9, y in the range of 0.05-0.1, and z in the range of 0.05-0.1 mixed with 32 volume percent fine alumina powder. The coated cloth plies were stacked into a 0°, 60°, −60°, 90°, −60°, 60°, 0° layup (the angles refer to the orientation of the warp or primary fiber tows relative to vertical direction defined as “0” in this case). The stack was placed onto a ¼″ thick steel plate coated with a mold release sheet (trade name “Kapton®” made by DuPont). A second sheet of Kapton® was placed over the stack. A set of 0.065″ thick metal shims were placed on the plate on each side of the stack to control the thickness. A second steel plate was set onto the Kapton® sheet covering the plies. The assembly was placed into a heated hydraulic actuated platen press that was pre-heated to 150° C. The press was closed to the shims and the temperature was increased at a rate of at 2 degrees per minute up to 400° C. and held for 1 hour. The press was then cooled and the assembly was removed. The pressed plate was removed from the assembly and the Kapton® was peeled away. The plate was then placed between two flat, smooth, graphite plates and the assembly was placed into an inert gas furnace for pyrolysis. The furnace had a stainless steel retort to contain the inert atmosphere and exclude oxygen. The furnace was heated at a rate of 2 degrees per minute up to 250° C., 1 degree per minute up to 650° C., and 3 degrees per minute up to 800-900° C. The furnace was then cooled at a rate of no more than 5° C. per minute. Once cooled, the plate was extracted from the assembly and excess loose powder was brushed off. The plate was placed into a liquid tight container and the container was placed into a vacuum chamber for vacuum infiltration. The chamber was evacuated to less than 250 millitorr pressure and held for ½ hour. The silicon carbide polymer was allowed to slowly enter the chamber and coat the plate until it was fully immersed. The vacuum was held for ½ hour after the plate was covered with liquid polymer. Air was then bled back into the chamber and the plate removed from the liquid polymer. Excess polymer was wiped off of the plate and the plate was placed onto a molybdenum sheet to prevent bonding to the graphite plates. A second molybdenum sheet was placed on top of the plate followed by a second graphite plate. The assembly was placed into the inert gas furnace and processed as described above. The pyrolysis cycle and vacuum infiltration was repeated 4-6 more times, or until the mass gain was less than 2% of the previous plate mass (the plate mass after previous pyrolysis cycle). The resulting plate had a fiber volume fraction of over 40% and a thickness of roughly 0.050-0.075 inches.

In an embodiment, the above example could be used to produce thicker components (plates of up to 2 inches thick have been demonstrated) by simply increasing the number of plies of coated cloth and increasing the thickness of the shims or spacers to hold the desired thickness.

### Example 2

Very Thin, High Stiffness Composite Sheet was Made Using the Following Process:

Four fabric plies of dimensions 12.5 inches long by 12.5 inches wide were cut from a roll of 1 k tow T-300 (Polyacronitrile—PAN based) carbon fiber cloth that was heat treated in a vacuum furnace at 1800° C. for a minimum of 2 hours. The plies were then uniformly coated with a slurry of 42% by volume of bimodal (4-7 micron/0.5-0.8 micron) SiC powder in a copolymer where R₁ was methyl, R₂ was ethynyl, x was in the range of 0.70-0.80, y was in the range of 0.05-0.1, and z was in the range of 0.05 and 0.1. The coated cloth plies were then stacked into a 0°, 60°, −60°, 90° layup. The stack was placed onto a ½″ thick flat, smooth graphite plate coated with a mold release sheet of parchment paper, a second sheet of parchment paper was placed over the stack. A set of 0.032 inch thick metal shims were placed on the plate on each side of the stack to control the thickness. A second graphite plate was set onto the parchment paper sheet covering the plies. The assembly was placed into a hydraulic actuated inert gas hot press. The press was closed to the shims and heated at 1-2 degrees per minute under argon up to 650-850° C. and held for 1 hour. The press was then cooled and the assembly was removed. The pressed plate was removed from the assembly and the mold release was peeled away and loose powder was brushed off. The plate was placed into a liquid tight container and the container was placed into a vacuum chamber. The chamber was evacuated to less than 250 millitor pressure and held for ½ hour. The silicon carbide polymer was allowed to slowly enter the chamber and coat the plate until it was fully immersed. The vacuum was held for ½ hour after the plate was covered with liquid polymer. Air was then bled back into the chamber and the plate removed from the liquid polymer. Excess polymer was wiped off of the plate and it was placed onto a molybdenum sheet to prevent bonding to the graphite plates. A second molybdenum sheet was placed on top of the plate followed by a second graphite plate. The assembly was placed into the inert gas furnace and processed heated to 650-850° C. (depending on fiber type). The vacuum infiltration, pyrolysis cycle was repeated 4-6 more times, or until the mass gain was less than 2% over the previous cycle mass. The resulting plate had a fiber volume fraction of over 40% and a thickness of roughly 0.030-0.048 inches.

In an embodiment, the above example could be used to produce thicker components (plates of up to 2 inches thick have been demonstrated) by simply increasing the number of plies of coated cloth and increasing the thickness of the shims or spacers to hold the desired thickness. In an embodiment, a vacuum hot press could also be used instead of an inert gas hot press.

### Example 3

A Low Friction Material with High Thermal and Electrical Conductivity was Produced using the Copolymer of the Present Invention where R₁ was Phenyl, R₂ was Allyl, x was 0.15, y was 0.45, and z was 0.4 as Follows:

200 grams of chopped copper fiber (roughly 5 mm in length) were mixed with 50 grams of sieved (200 mesh) pyrolyzed furfural. The materials were dry mixed until uniformly distributed. Twenty five (25) grams of the copolymer was mixed with 50 grams of furfural liquid. The liquid polymer blend was added to the above powder mix and the mixture was thoroughly stirred until uniformly mixed. The mixture was then pressed into a rectangular mold and 1000 psi was applied. The part was then removed from the mold, excess resin was wiped off and the part was placed onto a graphite plate. The part and plate were placed into an inert gas furnace and heated at 0.25-0.5 degrees per minute under nitrogen up to 850-900° C. and held for 1 hour. The part was then cooled at a rate of less than 5 degrees C. per minute down to room temperature. Loose powder was brushed off. The part was placed into a liquid tight container and the container was placed into a vacuum chamber. The chamber was evacuated to less than 250 millitor pressure and held for 1 hour. The copolymer was allowed to slowly enter the chamber and coat the plate until it was fully immersed. The vacuum was held for ½ hour after the plate was covered with liquid polymer. Air was then bled back into the chamber and the plate removed from the liquid polymer. Excess polymer was wiped off of the part and the part was placed onto a molybdenum sheet to prevent bonding to the graphite plate. The assembly was placed into the inert gas furnace and heated at a rate of 1-2 degrees per minute under argon up to 850-900° C. and held for 1 hour. After cooling, excess pyrolized polymer was brushed off and the part was ready for final machining. The part can be utilized, for example, as a motor brush, a low friction bearing, or as a sliding seal. Other uses include, for example, a troller slipper, a commutator for electrical power transmission, or a busing. Typically, the material contains a coefficient of friction of less than about 0.2, a thermal conductivity greater than about 100 w/m-deg-K, and an electrical conductivity greater than about 1 ohm.

In an embodiment, a low friction material is produced with chopped copper fiber present in a range between about 50% to about 80% by weight of the total mixture, glassy carbon powder present in a range between about 5% and about 15% by weight of the total mixture, and graphite powder present in a range between about 2% and about 10% by weight of the total mixture.

### Example 4

A Carbon Fiber Reinforced Material with Very High Temperature Capability was Produced Using the Following Process:

A slurry was made using a copolymer of the present invention where R₁ was methyl and R₂ was allyl with x in the range of 0.8-0.9, y in the range of 0.05-0.1, and z in the range of 0.05-0.1, hafnium diboride powder, hafnium carbide powder, and SiC powder. The slurry composition would be about 60-75% by mass hafnium diboride powder, about 5-10% by mass hafnium carbide powder, about 1-5% by mass silicate forming materials such as zirconium oxide powders (all powders would be in the 0.5-4 micron size range), and 15-25% by mass of copolymer of the present invention where R₁ was phenyl and R₂ was allyl with x in the range of 0.8-0.9, y in the range of 0.05-0.1, and z in the range of 0.05-0.1. The polymer content could be adjusted to optimize slurry rheology as needed. Plies of 3 K tow Granoc CN-80 plain weave pitch-based carbon fiber were cut into 13″×13″ size. The plies were uniformly coated with the slurry by passing each ply through Teflon rollers that have been coated with the slurry. The plies were passed through twice to assure uniform loading. Once coated, twelve (12) plies were stacked using a “quasi-isotropic” lay-up and placed onto a ½″ thick flat, smooth graphite plate coated with a mold release sheet of parchment paper. A second sheet of parchment paper was placed over the stack. A set of 0.125″ thick metal shims were placed on the plate on each side of the stack to control the thickness. A second graphite plate was set onto the parchment paper sheet covering the plies. The assembly was placed into a hydraulic actuated inert gas hot press. The press was closed to the shims and heated at about 1-2 degrees per minute under argon up to about 850-900° C. and held for about 1 hour. The press was then cooled and the assembly was removed. The pressed plate was removed from the assembly and the mold release was peeled away and loose powder was brushed off. The plate was placed into a liquid tight container and the container was placed into a vacuum chamber. The chamber was evacuated to less than about 250 millitorr pressure and held for ½ hour. The silicon carbide polymer was allowed to slowly enter the chamber and coat the plate until it was fully immersed. The vacuum was held for ½ hour after the plate was covered with liquid polymer. Air was then bled back into the chamber and the plate removed from the liquid polymer. Excess polymer was wiped off of the plate and it was placed onto a molybdenum sheet to prevent bonding to the graphite plates. A second molybdenum sheet was placed on top of the plate followed by a second graphite plate. The assembly was placed into the inert gas furnace and processed as described above. The vacuum infiltration, pyrolysis cycle was repeated 4-6 more times, or until the mass gain was less than 2% of the previous cycle mass. The resulting plate had a fiber volume fraction of over 40% and a thickness of about 0.120 inches. The plate could withstand short times (about 5-15 minutes) at temperature up to about 4500° F.

### Example 5

A High Temperature, Chemical Resistant, or Radiation Resistant Component was Made Using the Following Process:

AS-4 carbon fiber (a PAN based carbon fiber) cloth obtained from Cytec Corporation was braided onto a coated plain carbon steel mandrel to form a 1.5″ ID tube. A copolymer variant where R₁ was phenyl, R₂ was allyl, x was in the range of 0.2-0.4, y was in the range of 0.4-0.6, and z was in the range of 0.1-0.2 was mixed with SiC powder such that the ratio of powder to polymer by mass was 70%. The mixture/slurry was ball milled using zirconia milling media for at least 2 hours to form a uniform slurry. The slurry was painted onto the braided tubing (while it was on the mandrel) such that the mass gain of the tubing was between 50% and 100% compared to the uncoated braided material. The higher mass gains provide stronger, denser tubing. Once coated, the tubes were placed into an inert gas furnace and heated at 1-3° C. (preferably 2° C.) per minute up to a temperature of 850° C. and held for 1 hour. The parts were then cooled at 5° C. per minute or less. Once cool, the tubing was removed from the mandrel and cut to the desired length. Further densification and strengthening could be accomplished by immersing the tubing in the above slurry for ½ hour, removing the parts, and allowing the excess slurry to drain off for re-use. The parts would then be placed into a graphite or steel tray and placed into an inert gas furnace and heated at 1-3° C. (preferably 2° C.) per minute up to a temperature of 850° C. and held for 1 hour. The parts were then cooled at a rate of no more than 5° C. per minute. Further cycles using either a SiC slurry or neat polymer could be utilized, if required, to produce a stronger, denser, more gas-tight component. Parts made by the above described process or a slightly modified route can be utilized as follows:
1. As fabricated or one reinfiltration—chemical process equipment such as distillation or scrubber column packing or column structures.
2. Using a tighter multilayer braided tube, and at least 8 infiltration cycles with either/or slurry or neat resin can be used to produce gas-tight heat exchanger tubing.
3. Using SiC fiber in a tight, multi-layer braid or filament wound structure and at least 8 infiltration cycles with either/or slurry or neat resin can be used to produce gas-tight very high temperature capable nuclear fuel rod tubing.
4. Using non-carbon fiber types could be used such as Nextel 312, Nextel 312BN, Nextel 440 (alumina-silica-boron fibers), Nextel 550, 650, 720—alumina-silica fibers and Nextel 610-alumina fiber (all Nextels are ™ by 3M Company); Silicon carbide fibers such as Tyranno SA, Tyranno ZMI (all trademarked by UBE Industries), Hi Nicalon, Hi-Nicalon Type S, (trademarked by Nippon Carbon, Inc. or Sylramic (trademarked by Dow Coming/ATK)
5. The tubing could be formed by rolling slurry coated fabric and following the above process.

### Example 6

A Surface Leveling and Hardening for Composite or Ceramic Substrates was Made with the Following Process:

A slurry of copolymer variant where R₁ was phenyl and R₂ was allyl, x was in the range of 0.3-0.5, y was in the range of 0.2-0.3, and z was in the range of 0.3-0.5., hexane, mineral spirits, and SiC powder was produced. The slurry was 58% SiC powder and 30% of the silicon carbide polymer. The polymer was diluted with 5.6% hexane solvent, 5.6% mineral spirits, and 0.5% polyglycol wetting agent. The slurry was ball milled using zirconia media for a minimum of 2 hours. Once milled, the slurry was painted or spin coated onto the substrate surface, and allowed to dry.

Curing the coating for low temperature applications (i.e., less than about 500° C.) by a two-step cure process was performed as follows: with the first step of heating in moist air (humidity above about 70%) at a temperature of about 160° C. to about 180° C. for at least 1 hour. The second step was to heat in inert gas to 400-500° C. and hold for at least 1 hour.

Processing for high temperature applications (i.e., greater than about 500° C.) was performed as follows: The coated substrates were placed into an inert gas furnace and heated at a rate of about 0.5° C./minute to about 1° C./minute up to a temperature of about 850° C. and held for 1 hour. The parts were then cooled at a rate of about 5° C. per minute or less to room temperature. Subsequent coatings with neat resin followed by cure and/or pyrolysis could be used to further harden and smooth the coating.

The above process has been used to seal/decrease porosity in porous alumina/SiC tubing and crucibles providing a more gas tight component as well as seal/harden graphite and carbon/carbon composite materials.

### Example 7

A UV Curable, Variable Dielectric Constant, Surface and Leveling Coating was Made Using the Following Process:

A copolymer of the present invention where R₁ was methyl, R₂ was ethynl, x was in the range of 0.3-0.5, y was in the range of 0.2-0.3, and z was in the range of 0.3-0.4., was applied to a substrate such as a ceramic circuit board or a silicon wafer by spinning or spraying. The coating was exposed to UV-B illumination to cure the polymer by crosslinking through the ethylnyl groups. Alternatively, oxygen could be incorporated into the coating to lower the dielectric constant by providing a source of flowing moist air (i.e., greater than about 70% humidity) and heating the substrate to a temperature in a range of about 160° C. to about 180° C. The coating can be further hardened by heating in inert gas to a temperature of about 350° C. to about 500° C. The above process has been used to produce very thin (0.2-1.2 micrometer) coatings on electronic substrates.

### Example 8

Ceramic Composite Brake Rotors for Motorcycles, Automobiles, and Trucks have been Made Using the Following Process:

12 fabric plies of dimensions 12.5 inches long by 12.5 inches wide were cut from a roll of 1 k tow T-300 (Polyacrylonitrile-based) carbon fiber cloth that was heat treated in a vacuum furnace at 1800° C. for a minimum of 2 hours. The plies were then uniformly coated with a slurry of 42% by volume of bimodal (4-7 micron/0.5-0.8 micron) SiC powder in a copolymer of the present invention where R₁ was methyl, R₂ was allyl, x was in the range of 0.15-0.25, y was in the range of 0.45-0.5, and z was in the range of 0.3 and 0.5. The coated cloth plies were then stacked into a 0°, 60°, −60°, 90° layup. The stack was placed onto a ½″ thick flat, smooth graphite plate coated with a mold release sheet of parchment paper. A second sheet of parchment paper was placed over the stack. A set of 0.120 inch thick metal shims were placed on the plate on each side of the stack to control the thickness. A second graphite plate was set onto the parchment paper sheet covering the plies. The assembly was placed into a hydraulic actuated inert gas hot press. The press was closed to the shims and heated at 1-2° C./minute under argon up to about 650° C. to about 850° C. and held for 1 hour. The press was then cooled and the assembly was removed. The pressed plate was removed from the assembly and the mold release was peeled away and loose powder was brushed off. The plate was placed into a liquid tight container and the container was placed into a vacuum chamber. The chamber was evacuated to less than 250 millitor pressure and held for ½ hour.

A second type (more stoichiometric SiC forming) of silicon carbide forming copolymer (where R₁ was methyl, R₂ was allyl, x was in the range of 0.75-0.85, y was in the range of 0.05-0.1, and z was in the range of 0.1-0.2) was allowed to slowly enter the chamber and coat the plate until it was fully immersed. The vacuum was held for 1 hour after the plate was covered with liquid polymer. Nitrogen was then bled back into the chamber and the chamber was pressurized to about 50 psi. The pressure was held for roughly 2 hours and the chamber was slowly vented (over ½ hour) until atmospheric pressure was reached. The plate was removed from the liquid polymer. Excess polymer was wiped off of the plate and it was placed onto a molybdenum sheet to prevent bonding to the graphite plates. A second molybdenum sheet was placed on top of the plate followed by a second graphite plate. The assembly was placed into the inert gas furnace and processed heated to a temperature of about 850° C. to about 1000° C. The vacuum infiltration, pressure infiltration, and pyrolysis cycle was repeated 4-6 more times, or until the mass gain was less than 2% over the previous cycle mass. The resulting plate had a fiber volume fraction of over 40% and a thickness of roughly 0.120-0.135 inches.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A silicon composition comprising a copolymer having the formula:
H—[SiH₂CH₂]ₓₙ[Si(R₁)HCH₂]_{yn}[SiH(R₂)CH₂]_{zn}—H
wherein R₁ is methyl, phenyl, methoxy, ethoxy, or butoxy;
wherein R₂ is allyl, propargyl, or ethynyl; and
wherein x+y+z=1 with the proviso that x, y, and z are not 0.

2. The composition in accordance with claim 1 where R₁ is methyl, R₂ is allyl, x is in a range between about 0.6 and about 0.9, y is in a range between about 0.1 and about 0.15, and z is in a range between about 0.05 and about 0.1.

3. The composition in accordance with claim 1, wherein R₁ is methyl, R₂ is allyl, x is in a range between about 0.6 and about 0.9, y is in a range between about 0.07 and about 0.08, and z is in a range between about 0.07 and about 0.08.

4. The composition in accordance with claim 1, wherein R₁ is phenyl, R₂ is allyl, x is in a range between about 0.6 and about 0.9, y is in a range between about 0.1 and about 0.3, and z is in a range between about 0.05 and about 0.3.

5. The composition in accordance with claim 1, wherein R₁ is methyl, R₂ is ethynyl, x is in a range between about 0.6 and about 0.9, y is in a range between about 0.1 and about 0.3, and z is in a range between about 0.05 and about 0.3.

6. The composition in accordance with claim 1, wherein R₁ is methyl, R₂ is propargyl, x is in a range between about 0.6 and about 0.9, y is in a range between about 0.1 and about 0.3, and z is in a range between about 0.05 and about 0.3.

7. The composition in accordance with claim 1, wherein R₁ is phenyl, R₂ is propargyl, x is in a range between about 0.6 and about 0.9, y is in a range between about 0.1 and about 0.3, and z is in a range between about 0.05 and about 0.3.

8. The composition in accordance with claim 1, wherein R₁ is methyl, R₂ is allyl, x is in a range between about 0.1 and about 0.3, y is in a range between about 0.6 and about 0.8, and z is in a range between about 0.1 and about 0.2.

9. The composition in accordance with claim 1, wherein R₁ is methyl, R₂ is allyl, x is in a range between about 0.2 and about 0.25, y is in a range between about 0.1 and about 0.2, and z is in a range between about 0.55 and about 0.7.

10. The composition in accordance with claim 1, wherein R₁ is phenyl, R₂ is propargyl, x is in a range between about 0.2 and about 0.25, y is in a range between about 0.1 and about 0.2, and z is in a range between about 0.55 and about 0.7.

11. The composition in accordance with claim 1, wherein R₁ is phenyl, R₂ is allyl, x is in a range between about 0.1 and about 0.2, y is in a range between about 0.40 and about 0.45, and z is in a range between about 0.40 and about 0.45.

12. The composition in accordance with claim 1, further comprising at least one powder.

13. The composition in accordance with claim 12, wherein the powder has a size in a range between about 0.5 microns and about 45 microns.

14. The composition in accordance with claim 12, wherein the powder comprises hafnium diboride, hafnium carbide, zirconium diboride, zirconium carbide, silicon carbide, silicon nitride, boron carbide, graphite, or combinations thereof.

15. A silicon composition comprising a copolymer having the formula:
H—[SiH₂CH₂]ₓₙ[Si(R₁)HCH₂]_{yn}[SiH(R₂)CH₂]_{zn}—H
wherein R₁ is methyl;
wherein R₂ is propargyl, or ethynyl; and
wherein x+y+z=1 with the proviso that x, y, and z are not 0.

16. A silicon composition comprising a copolymer having the formula:
H—[SiH₂CH₂]ₓₙ[Si(R₁)HCH₂]_{yn}[SiH(R₂)CH₂]_{zn}—H
wherein R₁ is phenyl, methoxy, ethoxy, or butoxy;
wherein R₂ is allyl; and
wherein x+y+z=1 with the proviso that x, y, and z are not 0.

17. A method for making a silicon carbide based material comprising heating a copolymer of the formula:
H—[SiH₂CH₂]ₓₙ[Si(R₁)HCH₂]_{yn}[SiH(R₂)CH₂]_{zn}—H
wherein R₁ is methyl, phenyl, methoxy, ethoxy, or butoxy;
wherein R₂ is allyl, propargyl, or ethynyl; and
wherein x+y+z=1 with the proviso that x, y, and z are not 0.

18. The method in accordance with claim 17, wherein the copolymer is heated to a temperature in a range between about 160° C. to about 500° C.

19. The method in accordance with claim 18, wherein the copolymer is heated for a time in a range between about 30 minutes to about 240 minutes.

20. The method in accordance with claim 17, wherein the copolymer is heated with a platinum based catalyst.

21. The method in accordance with claim 17, wherein the copolymer is heated to a temperature in a range between about 90° C. to about 200° C. at a relative humidity of at least about 60% for about 1 hour to about 6 hours.

22. The method in accordance with claim 17, wherein R₂ is an ethynl group.

23. The method in accordance with claim 22, wherein the copolymer is cured via ultraviolet (UV) illumination.

24. The method in accordance with claim 17, wherein the copolymer is heated to a temperature in a range between about 400° C. to about 650° C.

25. The method in accordance with claim 24, wherein the copolymer is heated in an environment of inert gas, hydrogen gas or combination thereof.

26. The method in accordance with claim 17, wherein the copolymer is heated to a temperature in a range between about 700° C. to about 1200° C.

27. The method in accordance with claim 26, wherein the copolymer is heated in an environment of inert gas, hydrogen gas or combination thereof.

28. The method in accordance with claim 17, wherein the copolymer is heated to a temperature in a range between about 1200° C. to about 1800° C.

29. The method in accordance with claim 28, wherein the copolymer is heated in an environment of inert gas, hydrogen gas or combination thereof.

30. The method in accordance with claim 17, wherein the copolymer is mixed with a powdered refractory material having a size in a range between about 0.5 microns and about 45 microns.

31. The method in accordance with claim 30, wherein the powdered refractory material is hafnium diboride, hafnium carbide, zirconium diboride, zirconium carbide, silicon carbide, silicon nitride, or combinations thereof.

32. The method in accordance with claim 17, wherein the copolymer is mixed with silicon carbide, boron carbide, silicon nitride, carbon, graphite, or combinations thereof.

33. The method in accordance with claim 17, wherein R₁ is methyl; and R₂ is propargyl, or ethynyl.

34. The method in accordance with claim 17, wherein R₁ is phenyl, methoxy, ethoxy, or butoxy; and R₂ is allyl.

35. A silicon carbide based material made by the method of claim 17.

36. The silicon carbide based material in accordance with claim 35, having less than about 0.1% impurities.

37. The silicon carbide based material in accordance with claim 35, having a substantially 1:1 silicon to carbon stoichiometry.

38. The silicon carbide based material in accordance with claim 35, having a controlled silicon, carbon, and hydrogen ratio.

39. A method for making a composition comprising:
a) placing a mixture in a mold wherein the mixture includes at least one powder, at least one reinforcement material, liquid furfural, a catalyst, and a copolymer having the formula:
H—[SiH₂CH₂]ₓₙ[Si(R₁)HCH₂]_{yn}[SiH(R₂)CH₂]_{zn}—H
wherein R₁ is methyl, phenyl, methoxy, ethoxy, or butoxy;
wherein R₂ is allyl, propargyl, or ethynyl; and
wherein x+y+z=1 with the proviso that x, y, and z are not 0;
b) applying pressure to the mold in a range between about 500 psi and about 5000 psi; and
c) heating the molded mixture to a temperature in a range between about 700° C. and about 1200° C.

40. The method in accordance with claim 39, wherein the at least one powder comprises glassy carbon powder, graphite powder, boron nitride, silicon nitride, petroleum coke, copper powder, iron powder, titanium powder, zirconium powder, or combinations thereof.

41. The method in accordance with claim 39, wherein the at least one reinforcement material is chopped copper fiber.

42. The method in accordance with claim 41, wherein the chopped copper fiber is present in a range between about 50% to about 80% by weight of the total mixture.

43. The method in accordance with claim 40, wherein the powder is glassy carbon powder present in a range between about 5% and about 15% by weight of the total mixture.

44. The method in accordance with claim 40, wherein the powder is graphite powder present in a range between about 2% and about 10% by weight of the total mixture.

45. The method in accordance with claim 39, wherein the copolymer is present in a range between about 5% and about 15% by weight of the total mixture.

46. The method in accordance with claim 39, wherein the liquid furfural is present in a range between about 5% and about 15% by weight of the total mixture.

47. The method in accordance with claim 39, wherein the heating step occurs at a rate in a range between about 0.1° C. per minute to about 1° C. per minute.

48. The method in accordance with claim 39, wherein the heating step includes maintaining the temperature in a range between about 850° C. and about 900° C. for a time period in a range between about 1 and about 8 hours.

49. The method in accordance with claim 39, further comprising the steps of:
d) applying a vacuum of about 100 millitor to about 500 millitorr at a temperature in a range between about 10° C. to about 80° C. to the molded mixture;
e) adding a copolymer to the molded mixture wherein the copolymer has the formula:
H—[SiH₂CH₂]ₓₙ[Si(R₁)HCH₂]_{yn}[SiH(R₂)CH₂]_{zn}—H
wherein R₁ is methyl, phenyl, methoxy, ethoxy, or butoxy;
wherein R₂ is allyl, propargyl, or ethynyl; and wherein x+y+z=1 with the proviso that x, y, and z are not 0; and
f) heating the copolymer and molded mixture to a temperature in a range between about 700° C. and about 1200° C.

50. The method in accordance with claim 49, wherein the step of adding the copolymer further includes adding liquid furfural with a catalyst to the molded mixture.

51. The method in accordance with claim 50, wherein the step of adding the copolymer includes the copolymer present in a range between about 50% and 75% by weight of the total added mixture and the liquid furfural with the catalyst present in a range between 25% and 50% by weight of the total added mixture.

52. An article made by the method of claim 39.

53. The article in accordance with claim 52, having a coefficient of friction of less than about 0.2, a thermal conductivity greater than about 100 w/m-deg-K, and an electrical conductivity greater than about 1 ohm.

54. The article in accordance with claim 52, wherein the article is a motor brush, a troller slipper, a commutator for electrical power transmission, a bearing, or a bushing.

55. A method for making a composition comprising:
a) placing a reinforcing material and a slurry in a furnace wherein the mixture includes at least one powder and a copolymer having the formula
H—[SiH₂CH₂]ₓₙ[Si(R₁)HCH₂]_{yn}[SiH(R₂)CH₂]_{zn}—H
wherein R₁ is methyl, phenyl, methoxy, ethoxy, or butoxy;
wherein R₂ is allyl, propargyl, or ethynyl; and
wherein x+y+z=1 with the proviso that x, y, and z are not 0;
b) applying a vacuum of about 100 millitorr to about 500 millitorr to the furnace; and
c) heating the reinforcing material and the slurry to a temperature in a range between about 1200° C. to about 1800° C.

56. The method in accordance with claim 55, wherein the heating step occurs for a time period in a range between about 1 and about 3 hours.

57. The method in accordance with claim 55, wherein the slurry includes a bimodal silicon-carbide powder present in range between about 10% and about 65% by weight of the slurry.

58. The method in accordance with claim 57, wherein the bimodal silicon-carbide powder includes particles in a range between about 4 and about 7 microns and particles in a range between about 0.5 and about 0.8 microns.

59. The method in accordance with claim 55, wherein the reinforcing material is a polyacrylonitrile-based carbon fiber cloth, petroleum pitch-based fiber, chopper fiber, felt, or combinations thereof.

60. The method in accordance with claim 55, further comprising the steps of
d) applying a vacuum of about 100 millitorr to about 500 millitorr at a temperature range of about 10° C. to about 80° C. to the furnace to substantially remove the air;
e) adding a copolymer to the molded mixture wherein the copolymer has the formula
H—[SiH₂CH₂]ₓₙ[Si(R₁)HCH₂]_{yn}[SiH(R₂)CH₂]_{zn}—H
wherein R₁ is methyl, phenyl, methoxy, ethoxy, or butoxy;
wherein R₂ is allyl, propargyl, or ethynyl; and
wherein x+y+z=1 with the proviso that x, y, and z are not 0; and
f) heating the copolymer and molded mixture to a temperature in a range between about 850° C. and about 1000° C.

61. The method in accordance with claim 60, wherein steps (d) through (f) are repeated to produce an article with an open porosity of about 2% and about 10%.

62. An article made by the method of claim 55.

63. The article in accordance with claim 62, wherein the article is a brake rotor.
